(19) United States
(12) Patent Application Publication
(10) Pub. No.: US 2022/0267200 A1
(43) Pub. Date: Aug. 25, 2022

(54) GLASS STRUCTURES AND FABRICATION METHODS USING LASER INDUCED DEEP ETCHING

(71) Applicant: Incom, Inc., Charlton, MA (US)

(72) Inventors: Michael J. Minot, Andover, MA (US); Alexey Lyashenko, Holland, MA (US); Michael A. Detarando, Fiskdale, MA (US); Till Cremer, Worcester, MA (US); Cole J. Hamel, Worcester, MA (US); Mark A. Popecki, Durham, NH (US)

(21) Appl. No.: 17/677,082

(22) Filed: Feb. 22, 2022

Related U.S. Application Data
(60) Provisional application No. 63/151,161, filed on Feb. 19, 2021.

(51) Int. Cl. C03C 17/36

(52) U.S. Cl. CPC C03C 17/3649; C03C 2217/228; C03C 2217/261; C03C 2218/152; C03C 2218/151

(57) ABSTRACT

A method of making a functionalized device for amplification or multiplication of electrons includes making a glass channel array by a laser-induced deep etching process including (1) applying laser pulses to a glass substrate to form an array of modified areas, the glass substrate having a thickness less than 5 mm, the modified areas extending between two surfaces of the glass substrate, and (2) subsequently performing an etching process to selectively remove the modified areas and thereby form an array of through channels. Subsequently, one or more materials are deposited on the glass channel array to form the functionalized device.

### BACKGROUND

The present invention is related to the field of glass structures for functionalized devices such as microchannel plates.

### SUMMARY

In one aspect, a method is disclosed of making a functionalized device for amplification or multiplication of electrons. The method includes making a glass channel array by a laser-induced deep etching process including (1) applying laser pulses to a glass substrate to form an array of modified areas, the glass substrate having a thickness less than 5 mm, the modified areas extending between two surfaces of the glass substrate, and (2) subsequently performing an etching process to selectively remove the modified areas and thereby form an array of through channels. Subsequently, one or more materials are deposited on the glass channel array to form the functionalized device.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views.

FIG. 1 is a planar view of a glass channel array (GCA);

FIGS. 2A and 2B are close-up views of portions of the front and back respectively of the GCA;

FIG. 3 is a schematic close-up depiction of a section of the GCA showing pores and functionalizing layers;

FIG. 4 is another schematic view illustrating operation of a microchannel plate (MCP) employing the GCA;

FIG. 5 is a flow diagram of the manner of making a functionalized device;

FIG. 6 is a schematic depiction of pores having a zig-zag shape;

FIG. 7 depicts standard pore openings and funnel-shaped pore openings;

FIG. 8 is a schematic depiction of pores having a branching structure;

FIG. 9 depicts use of glass supports;

FIG. 10 is a planar view of a microchannel array device.

### DETAILED DESCRIPTION

Overview

The present disclosure is directed to the use of an innovative process technology to produce novel glass structures, including Glass Channel Arrays (GCAs) that can serve as substrate for functionalized devices, such as electron amplifying or multiplying devices. In one example, GCA substrates can be Atomic-Layer-Deposition (ALD) coated to produce microchannel plates (MCPs), which are referred to herein as ALD-GCA-MCPs. The technology also lends itself for fabrication of GCAs that can be used in microfluidic biological, as well as many other applications having commercial value.

Pure transparent materials such as quartz glass (fused silica and other glass materials) can be processed to generate 3D structures in a subtractive 3D process. The glass material is exposed to laser light where material is to be removed. The exposure to the laser changes the structure of the material so that it becomes more soluble in an etchant such as HF acid, KOH base, or other similar materials.

The process is executed by scanning focused ultrashort pulsed (fs or ps) laser radiation inside the glass, changing its properties locally in the focal volume. The laser exposed material is subsequently removed by wet-chemical etching (using an acid such as HF or an alkaline such as KOH or similar aqueous solutions).

Depending on the processing conditions, the etching rate of the laser-modified material can be much larger than the untreated glass, e.g., the selectivity (the ratio of the two etching rates) can be larger than 1400:1 in fused silica.

The laser processing is of a type that may be known under a variety of names as below. For ease and consistency of reference, the term Laser Induced Deep Etching (LIDE) is used herein.

1. Laser Induced Deep Etching (LIDE)

2. Selective Laser-induced Etching (SLE),

3. Femtosecond Laser Irradiation followed by Chemical Etching (FLICE),

4. Femtosecond Laser Assisted Etching (FLAE),

5. In-volume Selective Laser Etching (ISLE),

6. Femto-Etch™

7. FEMTOprint®

These technologies are able to produce 3D structures with micrometer precision.

The laser processing technology enables a number of novel features currently not practically available using more conventional means. For example, LIDE can be used to produce microchannel plates with unique and novel properties not achievable when produced by other means, such as a known “hollow core” capillary process, or conventional lead oxide (PbO) glass technology.

The process technologies enable the ability to produce GCA substrates and functionalized devices from a variety of transparent materials, including highly refractory materials, that do not lend themselves to use in existing processes. These materials include: vitreous glasses including fused silica, borosilicate glass (e.g., Borofloat™ or Willow™), alumino-silicate glasses, soda lime glass or ultra-low-expansion glass (ULE), and crystalline materials such as sapphire, quartz, YAG. Example compositions include:
Flexible MCPs made by ALD coating GCAs made from Corning's Willow Glass
High Temperature, Low Dark Rate MCPs made by ALD Coating GCAs made from Fused Silica or ULE Glass.
Doped Glass Compositions for specialty uses, such as Neutron Sensitive MCPs—This application might utilize Lithium- or Gadolinium-doped glass compositions which could be in the form of cast plates, ground and polished to a target thickness. Laser Induced Etching, SLE or similar methods could be used to sensitize the glass to etch pores to create the GCA structure that could be ALD coated to form Neutron Sensitive MCPs.

Customizable MCPs:
Custom Shapes—ultrafast 3D laser writing technologies enable custom shaped GCAs (squares, rectangles, circular, having an annular hole, solid border, etc.) to be fabricated quickly and cost effectively.
Custom Performance Specifications—Pore diameter, pitch, Open Area Ratio (OAR), GCA wafer thickness, L/d (thickness/pore diameter).
Micro-arrayed structures

Embodiments

In one embodiment MCP channel pore structures are fabricated using laser induced deep etching of fused silica glass. Fused silica glass is a very high temperature refractory material having a melting temperature greater than approximately 1650 C. Its high purity, low thermal expansion, and resistance to temperature make it a very attractive substrate for ALD-GCA-MCPs. It also lends itself exceedingly well to laser induced deep etching and similar methods.

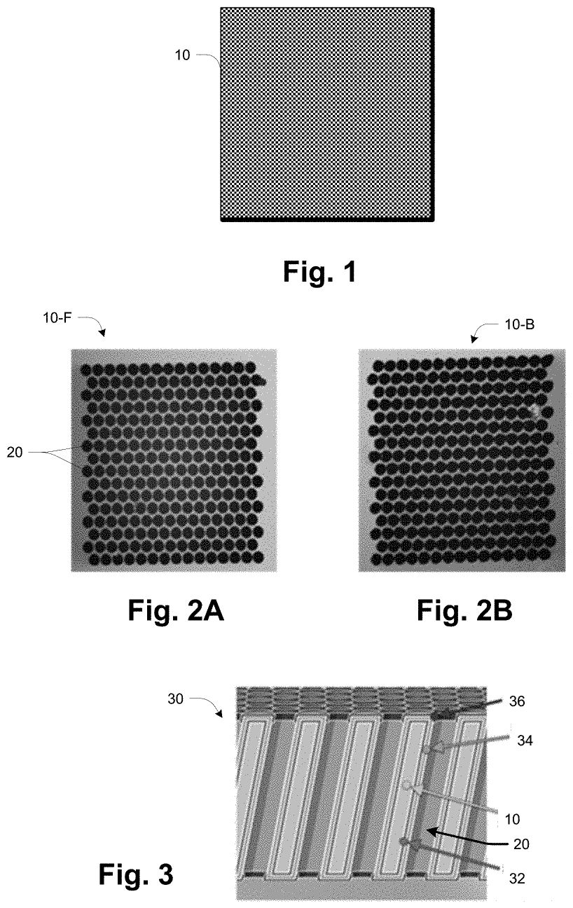

FIG. 1 is a planar view of a glass channel array (GCA) 10, which is a thin glass plate with a regular array of small holes (pores) that penetrate the plate from the front surface to the back surface. In one embodiment the plate has a relatively large area (e.g., on the order of 200 mm square), and a thickness of about 1.0 mm. The pores may have a diameter in the range of 5 μm to 40 μm. In one embodiment, the GCA 10 serves as the glass substrate of a micro channel plate (MCP) as described further below.

FIGS. 2A and 2B are close-up views of small sections of the front (10-F) and back (10-B) of the GCA 10. These show the above-mentioned holes or pores 20, formed in a tight array as illustrated.

FIG. 3 is a schematic depiction of the cross section of an ALD-GCA-MCP 30. The pores are shown as slightly angled, e.g., about 13 degrees from normal (straight through), for reasons discussed below. More generally, this angle may be in the range of 8 to 20 degrees. The GCA substrate 10 is functionalized with a resistive coating 32 and secondary electron emissive coating 34 that are applied to the pores 20 by means of ALD. Metal electrodes 36 are applied to the top and bottom surfaces.

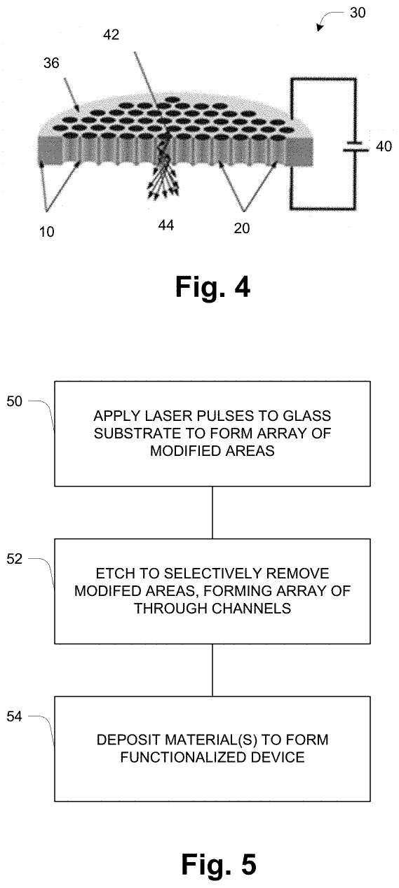

FIG. 4 is another schematic depiction of the ALD-GCA-MCP 30. The front and back surfaces of the MCP 30 are covered with metal electrodes 36, and the pore walls are made to have both a high electrical resistivity and a high secondary electron yield (SEY). During operation a high voltage 40 is applied across the MCP 30 such that the exit (back) surface is ˜1000 V higher in potential than the exit plane. An electron 42 entering the entry (front) side of the MCP 30 through one of the pore openings impinges on the channel wall, generating secondary electrons 44 in the emissive layer on the microchannel surface. These secondary electrons are accelerated towards the exit side of the MCP 30 by the electric field and impact on the channel wall to produce additional secondary electrons, resulting in a cascade of electrons along the length of the MCP channel. This results in a gain which may be on the order of 10³-10⁴ per MCP 30. In use, two or three MCPs 30 may be stacked on top of each other to produce gains as high as 10⁸ for example. The electrons 44 exiting an MCP 30 can be detected in a number of ways, including phosphor screens and various anode configurations.

Referring back to FIG. 3, the angling of the pores 20 helps with a problem that can occur in certain use of an MCP, in stacked arrangement that includes a planar photodetector above the MCP 30 that serves as the source for the incident electrons 42. In operation there can be back streaming of ions, moving upward in the view of FIG. 4, that can damage photodetector photocathodes. The angling of the pores 20 helps to prevent back-streaming ions from reaching the photodetector that is disposed above the MCP 30. In particular, in one arrangement a pair of MCPs 30 with their pores angling away from each other form a “chevron” pair (// \\) that can be effective against ion back streaming.

FIG. 5 is a high-level flow diagram for a manner of making a functionalized device for amplification or multiplication of electrons, such as the ALD-GCA-MCP 30, using LIDE in one embodiment. First, a glass channel array is made by a laser-induced deep etching process that includes, at 50, applying laser pulses to a glass substrate to form an array of modified areas therein, the glass substrate having a thickness less than 5 mm, the modified areas extending between two surfaces of the glass substrate, and then at 52 performing an etching process to selectively remove the modified areas and thereby form an array of through channels. At 54, one or more materials (e.g., resistive and/or emissive materials) are deposited on the glass channel array to form the functionalized device.

One benefit of using an LIDE process is the ability to make relative arbitrary shapes, based on scanning the laser in a corresponding pattern.

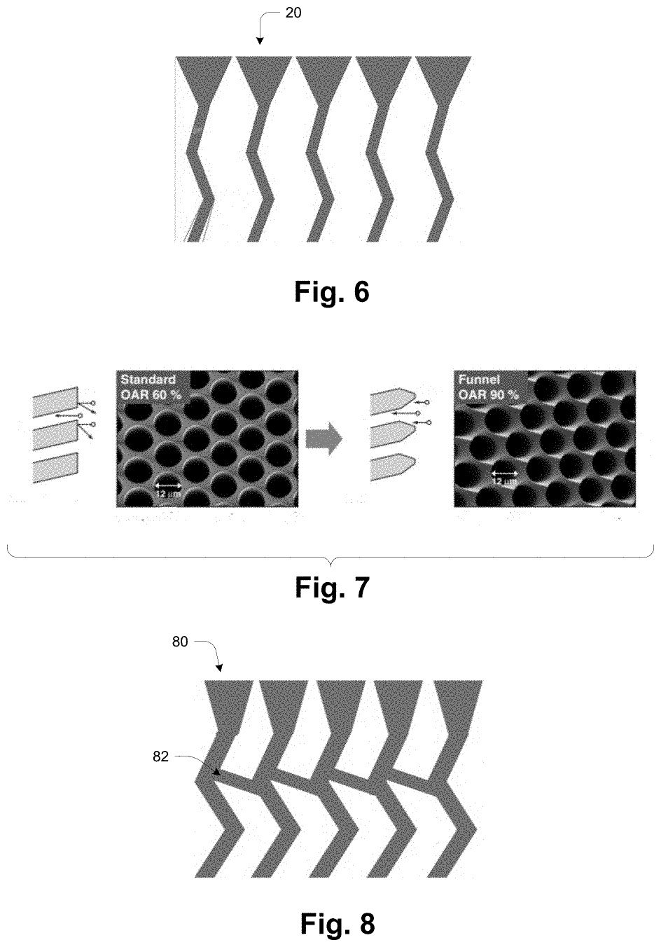

FIG. 6 shows an example in which the pores 20 are provided with an “S” or zig-zag shape, along with a funnel opening at the top. The zig-zag shape helps reduce back streaming of ions as described above, and can be provided in a single MCP 30 so that there is no need for a chevron pair or similar arrangement.

FIG. 7 shows additional detail for using a funnel-shaped opening. At left is a non-funnel (straight-sided) opening exhibiting an “open area ratio” (OAR) of about 60%. On the right is shown an MCP 30 having funnel-shaped openings and thus exhibiting a much higher OAR, on the order of 90%, with potentially higher gain. To provide such a funnel opening, one option is to activate the entry area of pores with laser light to deliberately control the funnel shape and to shape the funnel angle for optimized electron capture efficiency and timing, which may be relevant to high-timing resolution applications such as some time-of-flight (TOF) applications.

Another option is a “bowl-shaped” opening, which is similar to the funnel shape except having concave sloping sides rather than straight sides.

Another option for the shape of the pores 20 is a simple arc or curve, extending through the thickness of the glass substrate and of sufficient radius that there is no straight-line path for back-streaming ions.

FIG. 8 shows an alternative having branching pores 80, i.e., pores that are connected via cross-channels 82 within the structure. To overcome potential gain limitations from one channel, an initial pore 80 could be branched out into three or four pores 80 half-way through the plate, which can provide for increased gain while keeping the advantage of a single-plate multiplier. Another possibility is to have cross-linked pores half-way through a stack along with dendrite-like structures, which can also enable higher gains than a standard single-pore plate.

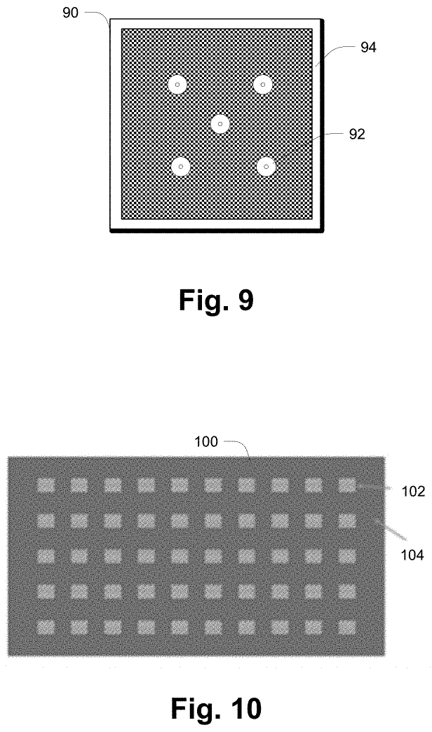

FIG. 9 shows a GCA Structure 90 with solid glass pads 92 for structural support. ALD-GCA-MCPs fabricated with solid glass support pads 92 can enable large-area photodetectors (LAPPDs) without spacers but with the pads 92 for structural support, with the advantage that there is no pressure applied to the MCPs 90 themselves. As shown, the peripheral edge 94 may be free of holes. Multiple MCPs 90 may be arranged grid-like in a large planar array, a grid framework that retains each MCP 90 at its blank edges 94.

FIG. 10 shows an example device 100 having micro-arrayed MCP structures, i.e., an array of porous sections 102 arranged within a surrounding solid section 104. This can provide for easy-to assemble, highly-paralleled single photon testing. These plates can be clamped together with fixturing only touching the solid glass parts, making assembly easier, leading to reduced issues with noise, pore outgassing, allow low-cost manufacturing, etc., and will allow for design of multi-array detectors that allow for highly localized light detection in individual “test cavities” that could be very small (i.e. 20×20 holes (200×200 um) for, for example, highly parallel (arrays of 1000×1000 individual units or more might be possible) testing of few or single-photon events (=super-high sensitivity) in, i.e. bioluminescence of tissues research in (bio-)medical and biochemical research. They would also have the advantage that the entire array can be analyzed at the back-end with one readout system for all test chambers.

REPRESENTATIVE PROCESSING

There are a number of alternative technical paths using these methods to produce a glass channel array microstructure suitable for further processing to form microchannel plates. These alternative technical paths depend on the selection of the glass material, as well as design and processing details. The following is one example process, in which a glass channel array (GCA) has 20-micron pores, with a pore-pore spacing (pitch) of 25 microns, and a bias angle of 13 degrees. The GCA is then appropriately coated with resistive and emissive coatings, and configured for electronic signal amplification as in a microchannel plate.

In one example of making a functionalized device, the laser source is a fiber chirped-pulse amplification (FCPA) laser providing pulsed laser radiation at a wavelength of 1030 nm, with pulse durations ranging from 300 to 3000 fs, a maximum pulse energy of 20 μJ at 500 kHz, and repetition rates ranging from 0 to 17 MHz. Laser radiation is focused by an objective (e.g., 20x, N/A=0.45) equipped with a collar for correction of spherical aberrations. Spherical aberrations of a non-collimated beam at a plane surface may be compensated according to the depth of modification. Polarization of the laser radiation may be linear and chosen to be perpendicular to the feed rate vector due to the fact that this orientation of polarization yields the highest selectivities.

Fused silica blocks are mounted and aligned on an XY system of air bearing stages, and processed as follows:

a) Irradiation with pulse durations tp<600 fs led to a varying width of process window.

b) Wider process windows can be found for tp>800 fs attributed to a more stable formation of nanograting (NG) at these pulse durations.

c) There is a dependence of laser-induced selective etching on pulse duration, feed rate, repetition rate and pulse energy for a numerical aperture of NA=0.45.

d) For fused silica glass a maximum selectivity up to ˜1400 and selective etching rates up to ˜290 μm/h may be obtained.

e) The selective etching rate with KOH may be higher than for etching with ˜2% HF.

f) The process may be scalable to higher feed rates without sacrificing selectivity within the range of parameters used for irradiation.

Once the GCA substrates are made, they can be loaded into an Atomic Layer Deposition (ALD) deposition chamber. ALD is used to first apply a resistive coating 32, followed by a Magnesium Oxide Secondary Emissive (SEE) coating 34. Following ALD coating, the coated substrate may be vacuum annealed. Subsequently, vacuum evaporation is used to apply a Nichrome (NiCr) electrode coating 36.

While various embodiments of the invention have been particularly shown and described, it will be understood by those skilled in the art that various changes in form and details may be made therein without departing from the spirit and scope of the invention as defined by the appended claims.

What is claimed is:

1. A method of making a functionalized device for amplification or multiplication of electrons, comprising:
making a glass channel array by a laser-induced deep etching process including (1) applying laser pulses to a glass substrate to form an array of modified areas therein, the glass substrate having a thickness less than 5 mm, the modified areas extending between two surfaces of the glass substrate, and (2) subsequently performing an etching process to selectively remove the modified areas and thereby form an array of through channels; and
subsequently depositing one or more materials on the glass channel array to form the functionalized device.

2. The method of claim 1, wherein the modified areas and through channels are formed at a non-zero angle relative to a normal to the substrate.

3. The method of claim 1, wherein the non-zero angle is in the range of 8-20 degrees.

4. The method of claim 1, wherein the modified areas are funnel-shaped at one surface, and the through channels have corresponding funnel-shaped openings.

5. The method of claim 4, wherein the funnel-shaped openings are sufficiently large to provide an open area ratio for the glass channel array of greater than 80%.

6. The method of claim 1, wherein the modified areas have diameters in the range of 5-40 um, and the through channels have corresponding channel diameters.

7. The method of claim 1, wherein depositing one or more material includes atomic-layer deposition of the materials.

8. The method of claim 7, wherein the materials are resistive and emissive materials forming respective resistive and emissive layers.

9. The method of claim 1, wherein the glass substrate is of a material being either a vitreous glass or a crystalline material.

10. The method of claim 9, wherein the material is a vitreous glass selected from fused silica, borosilicate glass, alumino-silicate glass, soda lime glass or ultra-low-expansion glass.

11. The method of claim 9, wherein the material is a crystalline material selected from sapphire, quartz, and yttrium-aluminum-garnet.

12. The method of claim 1, wherein the modified areas and through channels are formed in a zig-zag pattern to limit straight-line flow of particles through the functionalized device.

13. The method of claim 1, wherein the modified areas and through channels are formed to have branching within the glass substrate.

14. The method of claim 1, further including arranging glass supports on the functionalized device to support the device in use.

15. A functionalized device for amplification or multiplication of electrons, comprising:
a glass channel array having a glass substrate with an array of through channels therein, the glass substrate being either a vitreous glass or crystalline glass material; and
one or more functionalizing material layers on the glass channel array.

16. The functionalized device of claim 15, wherein the through channels have funnel-shaped openings at one surface of the glass channel substrate.

17. The functionalized device of claim 15, wherein the functionalizing material layers includes resistive and emissive materials forming respective resistive and emissive layers.

18. The functionalized device of claim 15, wherein the material is a vitreous glass selected from fused silica, borosilicate glass, alumino-silicate glass, soda lime glass or ultra-low-expansion glass.

19. The functionalized device of claim 15, wherein the material is a crystalline material selected from sapphire, quartz, and yttrium-aluminum-garnet.

20. The functionalized device of claim 15, wherein the through channels are formed in a zig-zag pattern to limit straight-line flow of particles through the functionalized device.
